(19) United States
(12) Patent Application Publication
(10) Pub. No.: US 2014/0065462 A1
(43) Pub. Date: Mar. 6, 2014

(54) INCREASED ENERGY DENSITY AND SWELLING CONTROL IN BATTERIES FOR PORTABLE ELECTRONIC DEVICES

(71) Applicants: Bookeun Oh, Fremont, CA (US); Richard M. Mank, Cupertino, CA (US)

(72) Inventors: Bookeun Oh, Fremont, CA (US); Richard M. Mank, Cupertino, CA (US)

(73) Assignee: APPLE INC., Cupertino, CA (US)

(21) Appl. No.: 13/597,408

(22) Filed: Aug. 29, 2012

(51) Int. Cl. H01M 10/02; H01M 10/04; H01M 4/583; H01M 4/525; H01M 2/02; H01M 2/16

(52) U.S. Cl. 429/136; 429/163; 29/623.2

(57) ABSTRACT

The disclosed embodiments relate to the design and manufacture of a battery cell. The battery cell includes a cathode containing a first cathode active material and a second cathode active material with a lower first coulombic efficiency and a higher energy density than the first cathode active material. The battery cell also includes an anode containing a silicon-based anode active material and a carbonaceous anode active material. Finally, the battery cell includes a pouch enclosing the cathode and the anode, wherein the pouch is flexible. Such blending of cathode and anode active materials may increase the energy density of the battery cell while mitigating the loss of capacity caused by the reaction of the silicon-based active material with lithium during initial charging and discharging of the battery cell.

### BACKGROUND

1. Field

The disclosed embodiments relate to batteries for portable electronic devices. More specifically, the disclosed embodiments relate to the design and manufacture of batteries for portable electronic devices with increased energy density and swelling control.

2. Related Art

Rechargeable batteries are presently used to provide power to a wide variety of portable electronic devices, including laptop computers, tablet computers, mobile phones, personal digital assistants (PDAs), digital music players and cordless power tools. The most commonly used type of rechargeable battery is a lithium battery, which can include a lithium-ion or a lithium-polymer battery.

Lithium-polymer batteries often include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

During operation, a lithium-polymer battery's capacity may diminish over time from an increase in internal impedance, electrode and/or electrolyte degradation, excessive heat, and/or abnormal use. For example, oxidation of electrolyte and/or degradation of cathode and anode material within a battery may be caused by repeated charge-discharge cycles and/or age, which in turn may cause a gradual reduction in the battery's capacity. As the battery continues to age and degrade, the capacity's rate of reduction may increase, particularly if the battery is continuously charged at a high charge voltage and/or operated at a high temperature.

Continued use of a lithium-polymer battery over time may also produce swelling in the battery's non-rigid cells and eventually cause the battery to exceed the designated maximum physical dimensions of the portable electronic device. Moreover, conventional battery-monitoring mechanisms may not include functionality to manage swelling of the battery. As a result, a user of the device may not be aware of the battery's swelling and/or degradation until the swelling results in physical damage to the device.

Hence, what is needed is a mechanism for minimizing swelling and improving capacity retention in high-voltage lithium-polymer batteries for portable electronic devices.

### SUMMARY

The disclosed embodiments relate to the design and manufacture of a battery cell. The battery cell includes a cathode containing a first cathode active material and a second cathode active material with a lower first coulombic efficiency and a higher energy density than the first cathode active material. The battery cell also includes an anode containing a silicon-based anode active material and a carbonaceous anode active material. Finally, the battery cell includes a pouch enclosing the cathode and the anode, wherein the pouch is flexible. Such blending of cathode and anode active materials may increase the energy density of the battery cell while mitigating the loss of capacity caused by the reaction of the silicon-based active material with lithium during initial charging and discharging of the battery cell.

In some embodiments, the battery cell also includes a separator disposed between the cathode and the anode. The separator includes a first side with a ceramic coating and a second side with a polymer coating. The ceramic coating may facilitate safe use of the silicon-based anode active material in the battery cell by promoting temperature stability and mitigating faults caused by mechanical stress, penetration, puncture, and/or electrical shorts.

In some embodiments, the second side adheres to the cathode or the anode upon applying a temperature in the range of 45° C. to 100° C. to the battery cell. For example, a pressure of at least 0.13 kilogram-force (kgf) per square millimeter and a temperature of 85° C. for about eight hours may be applied to the cathode, anode, and separator to melt the polymer coating and laminate (e.g., bond) the separator to the electrode facing the polymer coating. Such bonding may create a more solid battery cell, thereby increasing the battery cell's resistance to mechanical stress and/or swelling.

In some embodiments, the first side faces the cathode. For example, the first side may face the cathode to promote stabilization of the first and second cathode active materials by the ceramic coating.

In some embodiments, a first coulombic efficiency of the first cathode active material is greater than 92%, and the lower first coulombic efficiency of the second cathode active material is less than 88%.

In some embodiments, the first cathode active material includes lithium cobalt oxide, and the second cathode active material includes a lithium-nickel-based compound.

In some embodiments, the anode includes the silicon-based active material in the range of 0.5-25.0% by weight.

In some embodiments, the silicon-based anode active material includes a silicon oxide, and the carbonaceous anode active material includes graphite.

### BRIEF DESCRIPTION OF THE FIGURES

FIG. 1 shows the placement of a battery in a computer system in accordance with the disclosed embodiments.

FIG. 2 shows a battery cell in accordance with the disclosed embodiments.

FIG. 3 shows a set of layers for a battery cell in accordance with the disclosed embodiments.

FIG. 4 shows an exemplary plot in accordance with the disclosed embodiments.

FIG. 5 shows an exemplary plot in accordance with the disclosed embodiments.

FIG. 6 shows an exemplary plot in accordance with the disclosed embodiments.

FIG. 7 shows a flowchart illustrating the process of manufacturing a battery cell in accordance with the disclosed embodiments.

FIG. 8 shows a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

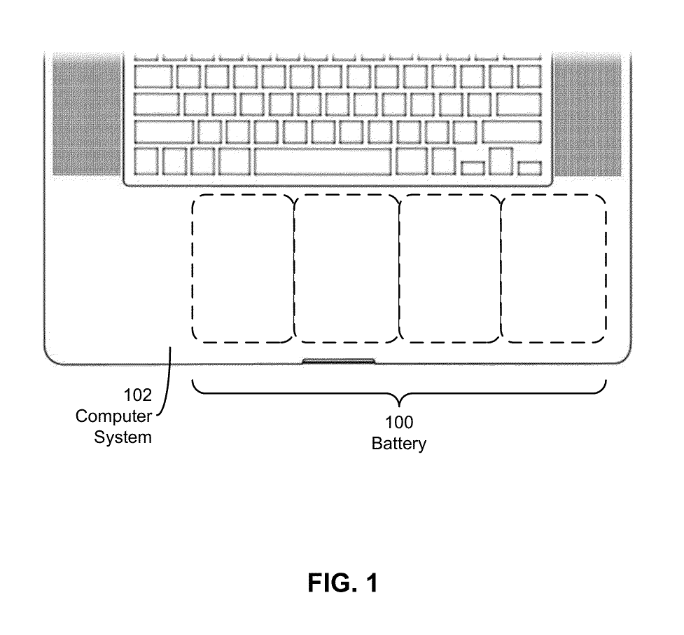

FIG. 1 shows the placement of a battery 100 in a computer system 102 in accordance with an embodiment. Computer system 102 may correspond to a laptop computer, personal digital assistant (PDA), portable media player, mobile phone, digital camera, tablet computer, and/or other portable electronic device. Battery 100 may correspond to a lithium-polymer battery and/or other type of power source for computer system 102. For example, battery 100 may include one or more lithium-polymer battery cells packaged in flexible pouches. The battery cells may then be connected in series and/or in parallel and used to power computer system 102.

In one or more embodiments, battery 100 is designed to accommodate the space constraints of computer system 102. For example, battery 100 may include battery cells of different sizes and thicknesses that are placed side-by-side, top-to-bottom, and/or stacked within computer system 102 to fill up the free space within computer system 102. The use of space within computer system 102 may additionally be optimized by omitting a separate enclosure for battery 100. For example, battery 100 may include non-removable pouches of lithium-polymer cells encased directly within the enclosure for computer system 102. As a result, the cells of battery 100 may be larger than the cells of a comparable removable battery, which in turn may provide increased battery capacity and weight savings over the removable battery.

To further facilitate use of computer system 102 with battery 100, battery 100 may be manufactured with a blend of active materials in both the cathode and anode. The anode may include a carbonaceous anode active material and a silicon-based anode active material to increase the energy density of battery 100. The cathode may include a first cathode active material and a second cathode active material with a lower first coulombic efficiency and higher energy density than the first cathode active material. The second cathode active material may mitigate the reduction in capacity caused by the reaction of the silicon-based anode active material with lithium from the cathode during initial charging and discharging of battery 100.

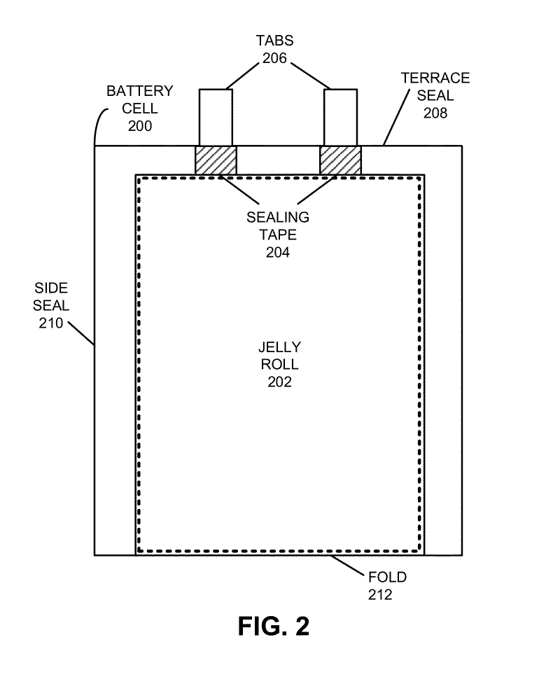

Use of the silicon-based anode active material in the battery cell may additionally be accommodated by disposing a separator with a ceramic coating on one side and a polymer coating on the other side between the cathode and anode. The combination of materials and/or coatings in the cathode, anode, and separator may increase the energy density of battery 100 over that of conventional batteries while mitigating swelling and/or a lower first coulombic efficiency associated with the use of the silicon-based anode active material in battery 100, as discussed in further detail below with respect to FIGS. 2-6.

FIG. 2 shows a battery cell 200 in accordance with the disclosed embodiments. Battery cell 200 may correspond to a lithium-ion and/or lithium-polymer cell that is used to power a portable electronic device. Battery cell 200 includes a jelly roll 202 containing a number of layers which are wound together, including a cathode with an active coating, a separator, and an anode with an active coating.

More specifically, jelly roll 202 may include one strip of cathode material (e.g., aluminum foil coated with a lithium compound) and one strip of anode material (e.g., copper foil coated with carbon) separated by one strip of separator material (e.g., conducting polymer electrolyte). As discussed below, active materials for the cathode and anode may be blended to increase the energy density of battery cell 200 while controlling swelling in battery cell 200. The cathode, anode, and separator layers may then be wound on a mandrel to form a spirally wound structure. Alternatively, the layers may be used to form other types of battery cell structures, such as bi-cell structures. Jelly rolls are well known in the art and will not be described further.

During assembly of battery cell 200, jelly roll 202 is enclosed in a flexible pouch, which is formed by folding a flexible sheet along a fold line 212. For example, the flexible sheet may be made of aluminum with a polymer film, such as polypropylene and/or polyethylene. After the flexible sheet is folded, the flexible sheet can be sealed, for example, by applying heat along a side seal 210 and along a terrace seal 208.

Jelly roll 202 also includes a set of conductive tabs 206 coupled to the cathode and the anode. Conductive tabs 206 may extend through seals in the pouch (for example, formed using sealing tape 204) to provide terminals for battery cell 200. Conductive tabs 206 may then be used to electrically couple battery cell 200 with one or more other battery cells to form a battery pack. For example, the battery pack may be formed by coupling the battery cells in a series, parallel, or series-and-parallel configuration.

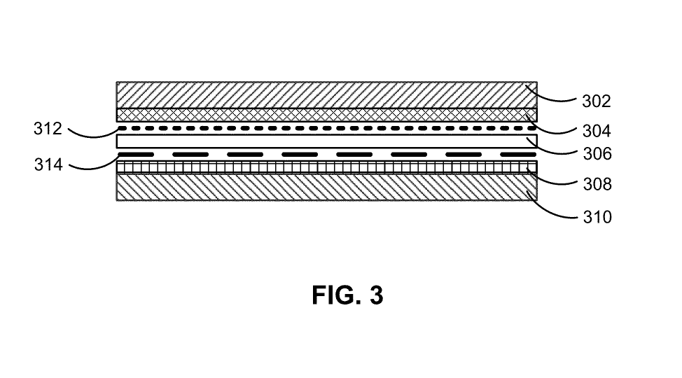

FIG. 3 shows a set of layers for a battery cell (e.g., battery cell 200 of FIG. 2) in accordance with an embodiment. The layers may include a cathode current collector 302, cathode active coating 304, separator 306, anode active coating 308, and anode current collector 310. The layers may be wound to create a jelly roll for the battery cell, such as jelly roll 202 of FIG. 2. Alternatively, the layers may be used to form other types of battery cell structures, such as bi-cell structures.

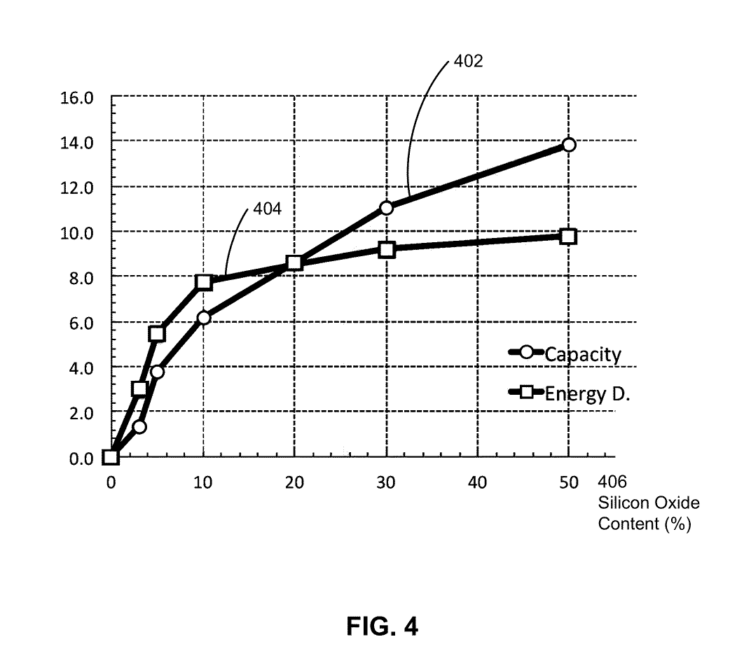

Cathode current collector 302 may be aluminum foil, anode current collector 310 may be copper foil, and separator 306 may include polypropylene and/or polyethylene. To increase the energy density of the battery cell, anode active coating 308 may include a blend of a silicon-based anode active material such as a silicon oxide and a carbonaceous anode active material such as graphite. The silicon-based anode active material may have a specific capacity of over 3500 mAh/g, which is about 10 times higher than that of graphite. In turn, the inclusion of the silicon-based anode active material in anode active coating 308 may increase the capacity of the battery cell over that of a conventional battery cell with an anode active coating that includes only the carbonaceous anode active material, as discussed in further detail below with respect to FIG. 4.

On the other hand, use of the silicon-based active material in the anode may be associated with a number of drawbacks. First, a portion (e.g., 30%) of the silicon-based active material may react irreversibly with lithium from the cathode during initial charging and discharging of the battery cell. As a result, the anode of the battery cell may have a lower first coulombic efficiency (e.g., first discharge capacity divided by first charge capacity) than a conventional anode that utilizes only the carbonaceous anode active material. For example, a silicon oxide anode active material may have a first coulombic efficiency of 70%, while a graphite anode active material may have a first coulombic efficiency of 94%. In turn, the silicon-based anode active material may produce a larger drop in the energy density of the battery cell after the first charge-discharge cycle than that of a battery cell containing the conventional anode.

Second, the silicon-based active material may increase swelling in the battery cell over that of a conventional battery cell. For example, an anode utilizing a silicon oxide as anode active material may expand three times more than a comparable anode utilizing only graphite as anode active material. Such swelling and/or physical expansion may preclude use of the silicon-based anode active material in a portable electronic device with a low swelling tolerance, such as a mobile phone, portable media player, and/or tablet computer.

In one or more embodiments, the battery cell is designed and manufactured to enable the increase in energy density provided by the silicon-based anode active material while mitigating swelling and/or initial loss of capacity associated with use of the silicon-based anode active in the battery cell. First, cathode active coating 304 may include a first cathode active material with a high first coulombic efficiency and a second cathode active material with a lower first coulombic efficiency and a higher energy density than the first cathode active material. For example, the first cathode active material may be lithium cobalt oxide and/or another compound containing lithium, nickel, and/or cobalt with a first coulombic efficiency that is higher than 92%. On the other hand, the second cathode active material may be a lithium-nickel-based compound with a first coulombic efficiency of less than 88%, such as lithium nickel oxide, lithium nickel cobalt manganese oxide, lithium nickel cobalt aluminum oxide, and/or lithium nickelate.

A number of techniques may be used to blend multiple cathode and anode active materials into cathode active coating 304 and anode active coating 308, respectively. For example, a powder-mixing technique may be used to make a slurry from two or more cathode or anode active materials, and the slurry may be coated onto foil to form the cathode or anode. Alternatively, particles of different cathode or anode active materials may be deposited onto a sheet of foil using a sputtering technique and/or deposition technique.

After the battery cell is assembled, initial charging and discharging of the battery cell may cause the silicon-based anode active material to react with lithium from both the first and second cathode active materials. In other words, extra lithium from the second cathode active material may be “donated” to the silicon-based anode active material to partially offset the irreversible capacity loss associated with the silicon-based anode active material after the first charge-discharge cycle. The remaining unreacted lithium from the first and second cathode active materials may subsequently be used in reversible charging and discharging of the battery cell, thus increasing the energy density of the battery cell over that of a battery cell that contains only the first cathode active material.

To mitigate swelling in the battery cell, the layers may also include a ceramic coating 312 on a first side of separator 306 and a polymer coating 314 on a second side of separator 306. Ceramic coating 312 and polymer coating 314 may be applied to separator 306 using a solution-coating technique, spray-coating technique, and/or other type of coating technique. Ceramic coating 312 may facilitate safe use of a high-energy anode active material such as a silicon oxide in the battery cell by promoting temperature stability in the battery cell and mitigating faults caused by mechanical stress, penetration, puncture, and/or electrical shorts. In addition, ceramic coating 312 may face cathode active coating 304 to stabilize (e.g., limit oxidation in) the cathode active materials of the battery cell.

Polymer coating 314 may be used to adhere separator 306 to the electrode facing polymer coating 314 (e.g., the anode) after a temperature in the range of 45° C. to 100° C. is applied to the battery cell. The temperature may also be applied with a specific pressure and/or for a pre-specified period of time. For example, to create a battery cell for a tablet computer, a set of steel plates and a heater may be used to apply a pressure of 900 kilogram-force (kgf) and a temperature of 85° C. for about eight hours to the layers. The application of pressure and/or temperature to the layers may melt polymer coating 314 and laminate (e.g., bond) separator 306 to the electrode, thus increasing the rigidity of the battery cell and/or the resistance of the battery cell to mechanical stress and/or swelling.

FIG. 4 shows an exemplary plot in accordance with the disclosed embodiments. More specifically, FIG. 4 shows a plot of percentage increases in capacity 402 and energy density 404 of a battery cell (e.g., battery cell 200 of FIG. 2) as a function of a percentage of silicon oxide content 406 by weight in the anode of the battery cell.

As shown in FIG. 4, an increase in silicon oxide content 406 from 0% to 10% in the anode may provide about an 6% increase in capacity 402 and a 8% increase in energy density 404. An increase in silicon oxide content 406 to 20% may also increase both capacity 402 and energy density 404 by about 8.5% over a conventional battery cell with 0% silicon oxide in the anode. Similarly, an increase in silicon oxide content 406 to 30% may provide a roughly 11% increase in capacity 402 and a 9% increase in energy density 404 over those of the conventional battery cell. Finally, an increase in silicon oxide content 406 to 50% of the anode may result in about a 14% increase in capacity 402 and a 10% increase in energy density 404 over those of the conventional battery cell.

In one or more embodiments, silicon oxide content 406 is limited to 0.5-25.0% of the anode by weight to mitigate reductions in operating voltage and/or increased swelling caused by increased silicon oxide content 406 in the battery cell. For example, an increase in silicon oxide content 406 of up to 10% of the anode by weight may be enabled by adapting the cathode active materials and separator in the battery cell to mitigate irreversible capacity loss and/or swelling caused by inclusion of the silicon oxide in the anode, as described above. On the other hand, the inclusion of 10-25% silicon oxide content 406 in the anode may produce swelling, initial capacity loss, and/or a reduction in operating voltage in the battery cell that require a more technical solution than the cathode active materials and separator coatings described above. Finally, the inclusion of more than 25% silicon oxide content 406 in the anode may cause increases in capacity 402 and/or energy density 404 to level off while adding to the swelling, irreversible capacity loss, and/or lowering of the operating voltage associated with use of the silicon oxide in the battery cell.

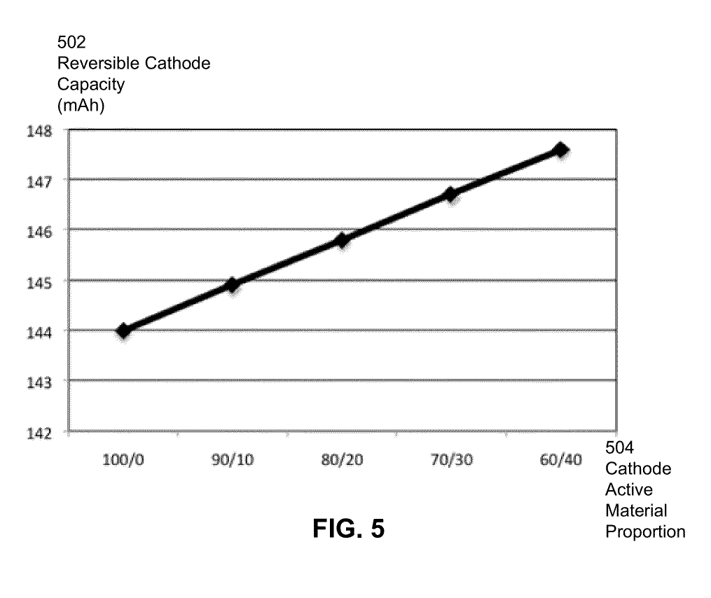

FIG. 5 shows an exemplary plot in accordance with the disclosed embodiments. In particular, FIG. 5 shows a plot of reversible cathode capacity 502 in mAh of a battery cell as a function of a cathode active material proportion 504 of a first cathode active material (e.g., lithium cobalt oxide) and a second cathode active material with a lower first coulombic efficiency and a higher energy density than the first cathode active material (e.g., a lithium-nickel-based compound). Values of reversible cathode capacity 502 may be calculated for a battery cell containing an anode with 3% silicon-based anode active material by weight and 97% graphite by weight.

As shown in FIG. 5, reversible cathode capacity 502 may increase roughly linearly with the percentage of the second cathode active material in the cathode of the battery cell. For example, reversible cathode capacity 502 may be 144.0 mAh for a battery cell with 100% first cathode active material and 0% second cathode active material. Next, reversible cathode capacity 502 may increase to 144.9 mAh for a battery cell with 90% first cathode active material and 10% second cathode active material and 145.8 mAh for a battery cell with 80% first cathode active material and 20% second cathode active material. Finally, reversible cathode capacity 502 may be 146.7 mAh for a battery cell with 70% first cathode active material and 30% second cathode active material and 147.6 mAh for a battery cell with 60% first cathode active material and 40% second cathode active material.

Such increases in reversible cathode capacity 502 may be enabled by additional lithium in the second cathode active material. For example, the lower first coulombic efficiency of the second cathode active material may allow the second cathode active material to “donate” lithium to a silicon-based anode active material in the anode of the battery cell during the first charge-discharge cycle of the battery cell. Lithium in the first and second cathode active materials that is not used in the reaction with the silicon-based anode active material may then be used in subsequent charging and discharging of the battery cell, resulting in the variations in reversible cathode capacity 502 shown in FIG. 5.

On the other hand, the high-temperature stability of the battery cell may decrease as a function of the percentage of second cathode active material in cathode active material proportion 504. As a result, inclusion of more than 40% second cathode active material in the cathode may cause the battery cell to swell beyond the swelling tolerance of a portable electronic device containing the battery cell, thus preventing safe use of the battery cell with the portable electronic device.

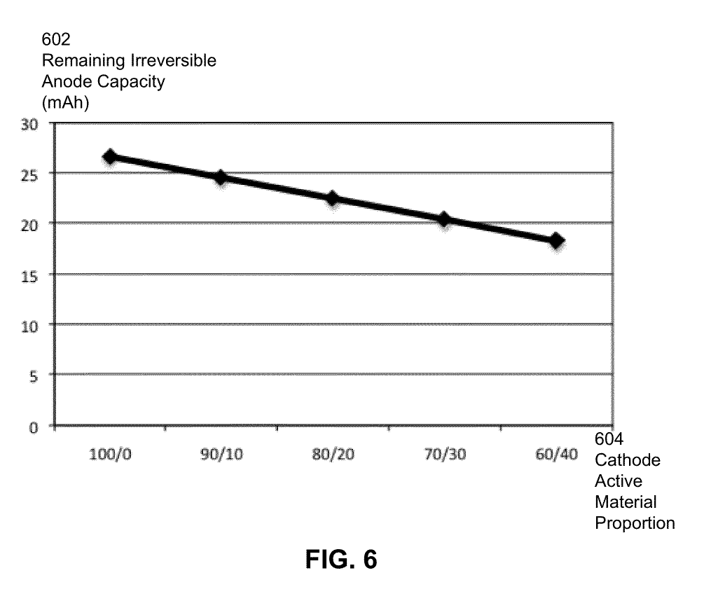

FIG. 6 shows an exemplary plot in accordance with the disclosed embodiments. In particular, FIG. 6 shows a plot of remaining irreversible anode capacity 602 in mAh of a battery cell as a function of a cathode active material proportion 604 of a first cathode active material (e.g., lithium cobalt oxide) and a second cathode active material with a lower first coulombic efficiency and a higher energy density than the first cathode active material (e.g., a lithium-nickel-based compound). As with the plot of FIG. 5, the plot of FIG. 6 may show remaining irreversible anode capacity 602 for a battery cell containing an anode with 3% silicon-based anode active material by weight and 97% graphite by weight.

As shown in FIG. 6, remaining irreversible anode capacity 602 may be inversely proportional to the percentage of second cathode active material in the cathode of the battery cell. For example, remaining irreversible anode capacity 602 may be 26.65 mAh for a battery cell with 100% first cathode active material and 0% second cathode active material and 24.55 mAh for a battery cell with 90% first cathode active material and 10% second cathode active material. Remaining irreversible anode capacity 602 may then drop to 22.45 mAh for a battery cell with 80% first cathode active material and 20% second cathode active material and to 20.35 mAh for a battery cell with 70% first cathode active material and 30% second cathode active material. Finally, remaining irreversible anode capacity 602 may be 18.25 mAh for a battery cell with 60% first cathode active material and 40% second cathode active material.

Like the increase in reversible cathode capacity 502 of FIG. 5, the reduction in remaining irreversible anode capacity 602 may be enabled by additional lithium in the second cathode active material. For example, lithium from a battery cell containing 40% second cathode active material may reduce remaining irreversible anode capacity 602 to be balanced by the first cathode active material by over 8 mAh. However, as mentioned above, more than 40% second cathode active material in the battery cell may cause excess swelling that prevents use of the battery cell in a space-constrained portable electronic device. Consequently, cathode active material proportion 604 in the battery cell may range from greater than 0% to up to 40% second cathode active material.

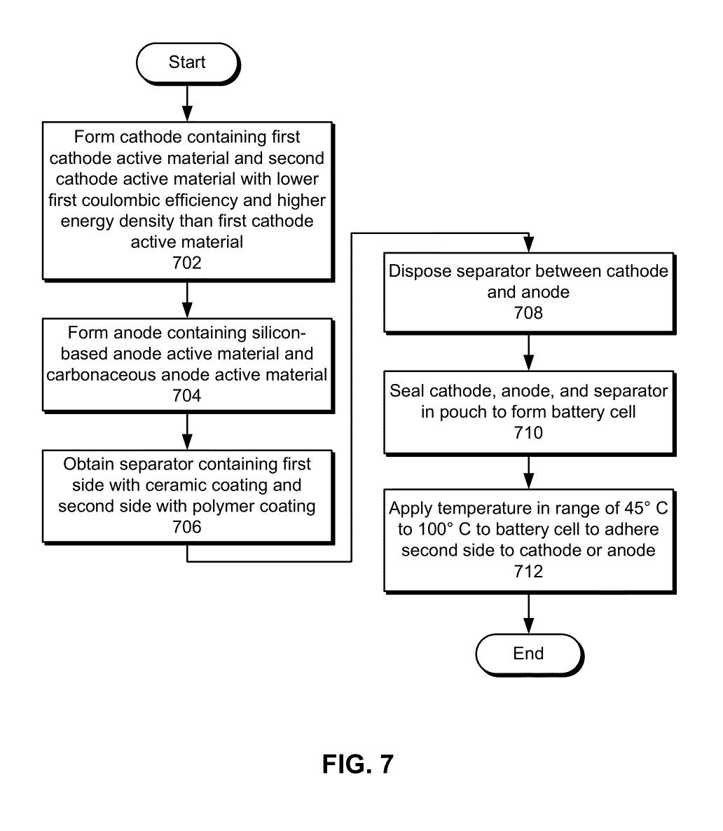

FIG. 7 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

Initially, a cathode containing a first cathode active material and a second cathode active material with a lower first coulombic efficiency and a higher energy density than the first cathode active material is formed (operation 702). The first cathode active material may have a first coulombic efficiency of greater than 92%, and the second cathode active material may have a lower first coulombic efficiency of less than 88%. For example, the first cathode active material may be lithium cobalt oxide, and the second cathode active material may be a lithium-nickel-based compound. To form the cathode, the first and second cathode active materials may be added to a cathode substrate using a powder-mixing technique, a sputtering technique, and/or a deposition technique.

Next, an anode containing a silicon-based anode active material and a carbonaceous anode active material is formed (operation 704). The silicon-based anode active material may be a silicon oxide, and the carbonaceous anode active material may be graphite. The anode may contain 0.5-25.0% of the silicon-based anode active material by weight. As with the cathode, a powder-mixing technique, sputtering technique, and/or deposition technique may be used to add the anode active materials to an anode substrate.

A separator containing a first side with a ceramic coating and a second side with a polymer coating is also obtained (operation 706) and disposed between the cathode and anode (operation 708). For example, the separator may be placed between the cathode and anode so that the first side faces the cathode and the second side faces the anode.

The cathode, anode, and separator are then sealed in the pouch to form the battery cell (operation 710). For example, the battery cell may be formed by placing the cathode, anode, and separator into the pouch, filling the pouch with electrolyte, and forming side and terrace seals along the edges of the pouch. Finally, a temperature in the range of 45° C. to 100° C. is applied to the battery cell to adhere the second side of the separator to the cathode or the anode (operation 712). For example, the temperature and a pressure of at least 0.13 kgf per square millimeter may be applied to the battery cell for about eight hours to melt the polymer coating and laminate the separator to the electrode facing the coating. Because the polymer coating increases the rigidity of the battery cell, the battery cell may be more resistant to mechanical stress and/or swelling than a conventional battery cell that lacks the polymer coating. In turn, the polymer coating may offset the increased swelling associated with the silicon-based anode active material, thus facilitating safe use of the battery cell in a space-constrained portable electronic device.

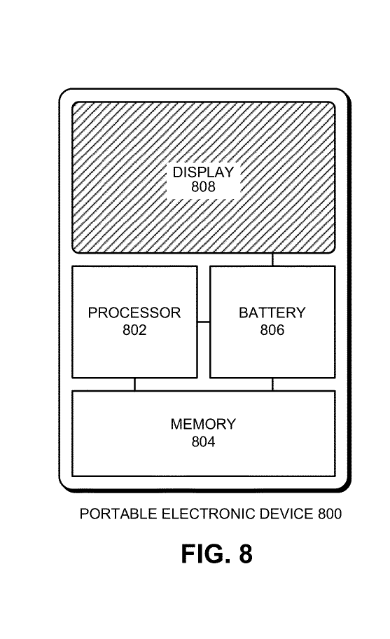

The above-described rechargeable battery cell can generally be used in any type of electronic device. For example, FIG. 8 illustrates a portable electronic device 800 which includes a processor 802, a memory 804 and a display 808, which are all powered by a battery 806. Portable electronic device 800 may correspond to a laptop computer, mobile phone, PDA, tablet computer, portable media player, digital camera, and/or other type of battery-powered electronic device. Battery 806 may correspond to a battery pack that includes one or more battery cells. Each battery cell may include a cathode containing a first cathode active material and a second cathode active material with a lower first coulombic efficiency and a higher energy density than the first cathode active material. The battery cell may also include an anode with a silicon-based anode active material and a carbonaceous anode active material. Finally, the battery cell may include a separator containing a first side with a ceramic coating and a second side with a polymer coating.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A battery cell, comprising:
a cathode, comprising:
a first cathode active material; and
a second cathode active material with a lower first coulombic efficiency and a higher energy density than the first cathode active material;
an anode, comprising:
a silicon-based anode active material; and
a carbonaceous anode active material; and
a pouch enclosing the cathode and the anode, wherein the pouch is flexible.

2. The battery cell of claim 1, further comprising:
a separator disposed between the cathode and the anode, comprising:
a first side with a ceramic coating; and
a second side with a polymer coating.

3. The battery cell of claim 2, wherein the second side adheres to the cathode or the anode upon applying a temperature in the range of 45° C. to 100° C. to the battery cell.

4. The battery cell of claim 2, wherein the first side faces the cathode.

5. The battery cell of claim 1,
wherein a first coulombic efficiency of the first cathode active material is greater than 92%, and
wherein the lower first coulombic efficiency of the second cathode active material is less than 88%.

6. The battery cell of claim 1,
wherein the first cathode active material comprises lithium cobalt oxide, and
wherein the second cathode active material comprises a lithium-nickel-based compound.

7. The battery cell of claim 1, wherein the anode comprises the silicon-based active material in the range of 0.5-25.0% by weight.

8. The battery cell of claim 1,
wherein the silicon-based anode active material comprises a silicon oxide, and
wherein the carbonaceous anode active material comprises graphite.

9. A battery cell, comprising:
a cathode;
an anode;
a separator, comprising:
a first side with a ceramic coating; and
a second side with a polymer coating; and
a pouch enclosing the cathode, the anode, and the separator, wherein the pouch is flexible.

10. The battery cell of claim 9,
wherein the cathode comprises:
a first cathode active material; and
a second cathode active material with a lower first coulombic efficiency and a higher energy density than the first cathode active material, and
wherein the anode comprises:
a silicon-based anode active material; and
a carbonaceous anode active material.

11. The battery cell of claim 10,
wherein a first coulombic efficiency of the first cathode active material is greater than 92%, and
wherein the lower first coulombic efficiency of the second cathode active material is less than 88%.

12. The battery cell of claim 10, wherein the anode comprises the silicon-based active material in the range of 0.5-25.0% by weight.

13. A method for manufacturing a battery cell, comprising:
forming a cathode comprising a first cathode active material and a second cathode active material with a lower first coulombic efficiency and a higher energy density than the first cathode active material;
forming an anode comprising a silicon-based anode active material and a carbonaceous anode active material; and
sealing the cathode and the anode in a pouch to form the battery cell, wherein the pouch is flexible.

14. The method of claim 13, further comprising:
obtaining a separator comprising a first side with a ceramic coating and a second side with a polymer coating; and
disposing the separator between the cathode and the anode.

15. The method of claim 14, further comprising:
winding the cathode, the anode, and the separator to create a jelly roll.

16. The method of claim 14, further comprising:
applying a temperature in the range of 45° C. to 100° C. to the battery cell to adhere the second side to the cathode or the anode.

17. The method of claim 13, wherein the cathode is formed using at least one of a powder-mixing technique, a sputtering technique, and a deposition technique.

18. The method of claim 13,
wherein a first coulombic efficiency of the first cathode active material is greater than 92%, and
wherein the lower first coulombic efficiency of the second cathode active material is less than 88%.

19. The method of claim 13,
wherein the first cathode active material comprises lithium cobalt oxide, and
wherein the second cathode active material comprises a lithium-nickel-based compound.

20. The method of claim 13, wherein the anode comprises the silicon-based active material in the range of 0.5-25.0% by weight.

21. The method of claim 13,
wherein the silicon-based anode active material comprises a silicon oxide, and
wherein the carbonaceous anode active material comprises graphite.

22. A portable electronic device, comprising:
a set of components powered by a battery pack; and
the battery pack, comprising:
a battery cell, comprising:
a cathode, comprising:
a first cathode active material; and
a second cathode active material with a lower first coulombic efficiency and a higher energy density than the first cathode active material;
an anode, comprising:
a silicon-based anode active material; and
a carbonaceous anode active material; and
a pouch enclosing the cathode and the anode,
wherein the pouch is flexible.

23. The portable electronic device of claim 22, wherein the battery cell further comprises:
a separator disposed between the cathode and the anode, comprising:
a first side with a ceramic coating; and
a second side with a polymer coating.

24. The portable electronic device of claim 23, wherein the second side adheres to the cathode or the anode upon applying a temperature in the range of 45° C. to 100° C. to the battery cell.

25. The portable electronic device of claim 23, wherein the first side faces the cathode.

26. The portable electronic device of claim 22,
wherein a first coulombic efficiency of the first cathode active material is greater than 92%, and
wherein the lower first coulombic efficiency of the second cathode active material is less than 88%.

27. The portable electronic device of claim 22,
wherein the first cathode active material comprises lithium cobalt oxide, and
wherein the second cathode active material comprises a lithium-nickel-based compound.

28. The portable electronic device of claim 22, wherein the anode comprises the silicon-based active material in the range of 0.5-25.0% by weight.

29. The portable electronic device of claim 22,
wherein the silicon-based anode active material comprises a silicon oxide, and
wherein the carbonaceous anode active material comprises graphite.
